(19) United States
(12) Patent Application Publication
(10) Pub. No.: US 2011/0090139 A1
(43) Pub. Date: Apr. 21, 2011

(54) ACTIVE DEVICE ARRAY SUBSTRATE, LIQUID CRYSTAL DISPLAY PANEL AND ELECTRONIC APPARATUS

(75) Inventor: CHIEN-HSUEH CHIANG, Miao-Li County (TW)

(73) Assignee: CHIMEI INNOLUX CORPORATION, Miao-Li County (TW)

(21) Appl. No.: 12/900,501

(22) Filed: Oct. 8, 2010

(30) Foreign Application Priority Data
Oct. 16, 2009 (CN) 200910308371.5

(51) Int. Cl. G09G 3/36; G09G 3/20

(52) U.S. Cl. 345/87; 345/55

(57) ABSTRACT

An active device array substrate includes a plurality of pixel units, a plurality of scan lines, a plurality of data lines. Each of the pixel units has an active device. The pixel units are arranged to form at least one group of a first pixel unit column and a second pixel unit column adjacent to each other, and the pixel units in the first pixel unit column and the second pixel unit column are vertically arranged. The scan lines and the data lines electrically connected to the corresponding active devices of the pixel units. Herein, the data line connected to the active devices of the pixel units of the first pixel unit column and the data line connected to the active devices of the pixel units of the second pixel unit column form a closed loop.

### BACKGROUND OF THE DISCLOSURE

1. Field of the Disclosure

The disclosure relates to an active device array substrate and a liquid crystal display (LCD) panel, and more particularly to an active device array substrate and an LCD panel capable of reducing the possibility of forming line-cut.

2. Description of Related Art

FIG. 1 is a schematic view of a typical active device array substrate. Referring to FIG. 1, the active device array substrate 100 includes a plurality of pixel units 110, a plurality of scan lines G1, G2, and G3˜Gn, and a plurality of data lines D1, D2, and D3˜Dn. The pixel units 110 are formed by active devices TFT and pixel electrodes PE. It should be noted that, a first pixel unit column 112 and a second pixel unit column 114 at two side of a single data line D1 share the data line D1 to transmit driving signals.

The arrow A shown in FIG. 1 is the charging path of the active device array substrate 100. At each intersection (as shown at the region B) of any one of the data lines D1˜Dn, e.g. D1, and the scan lines G1˜Gn, e.g. G1 and G2, there are two active devices TFT located on the charging path A. Based on the foregoing design, the number of the data lines becomes half, and this design is so-called half data double gate (HDDG).

However, there is a useless dummy line DL existing between two adjacent data lines D1 and D2 on the foregoing active device array substrate 100. Therefore, the circuit area can not be effectively utilized in such a circuit design. Furthermore, when the shared data line D1 is broken, the pixel units 110 at the two side of the data line D1 can not normally operate.

### SUMMARY OF THE DISCLOSURE

Based on the above, an embodiment of the disclosure provides an active device array substrate including a plurality of pixel units, a plurality of scan lines, and a plurality of data lines. Each of the pixel units has an active device. The pixel units are arranged to form at least one set of a first pixel unit column and a second pixel unit column adjacent to each other, and the pixel units in the first pixel unit column and the second pixel unit column are vertically arranged. The scan lines and the data lines electrically connected to the corresponding active devices of the pixel units. Herein, the data line connected to the active devices of the pixel units of the first pixel unit column and the data line connected to the active devices of the pixel units of the second pixel unit column form a closed loop. In the first pixel unit column, the active devices of the pixel units are connected to the scan lines of an odd-number position, and in the second pixel unit column, the active devices of the pixel units are connected to the scan lines of an even-number position. Or, in the first pixel unit column, the active devices of the pixel units are connected to the scan lines of the even-number position, and in the second pixel unit column, the active devices of the pixel units are connected to the scan lines of the odd-number position.

Another embodiment of the disclosure provides an LCD panel including the foregoing active device array substrate, an opposite substrate and a liquid crystal layer. The opposite substrate is disposed opposite to the active device array substrate. The liquid crystal layer is disposed between the active device array substrate and the opposite substrate.

Another embodiment of the disclosure provides an electronic apparatus including the foregoing LCD panel and an input unit. The input unit is coupled to the LCD panel and inputs a signal to the LCD panel for providing images.

In order to make the aforementioned and other features and advantages of the disclosure more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a typical active device array substrate.

FIG. 2 is a schematic view of an active device array substrate according to an embodiment of the disclosure.

FIG. 3 is a timing diagram of driving waveforms of an active device array substrate according to an embodiment of the disclosure.

FIG. 4 is a schematic view illustrating the line-cut occurs in the active device array substrate shown in FIG. 2.

FIG. 5 is a schematic view illustrating signal transmitting paths in the active device array substrate shown in FIG. 2.

FIG. 6 is a schematic view of an active device array substrate according to another embodiment of the disclosure.

FIG. 7 is a schematic view illustrating an LCD panel according to an embodiment of the disclosure.

FIG. 8 is a schematic diagram of an electronic apparatus according to an embodiment of the disclosure.

### DESCRIPTION OF EMBODIMENTS

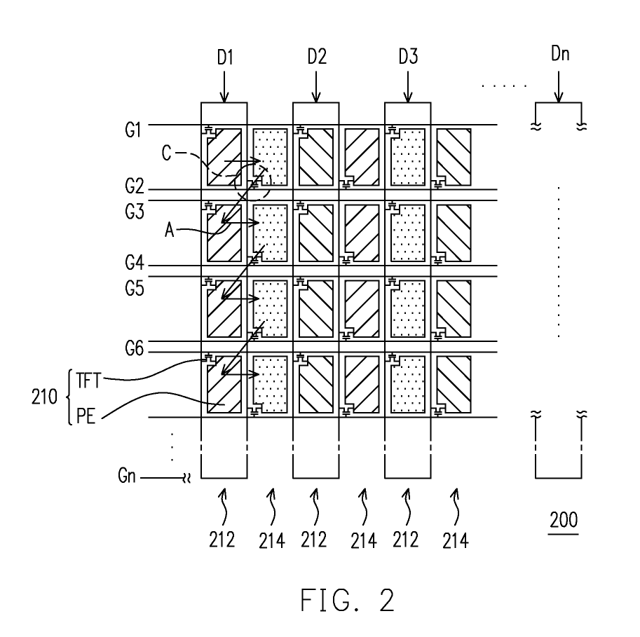

FIG. 2 is a schematic view of an active device array substrate according to an embodiment of the disclosure. Referring to FIG. 2, the active device array substrate 200 includes a plurality of pixel units 210, a plurality of scan lines G1, G2, and G3˜Gn, and a plurality of data lines D1, D2, and D3˜Dn. Each of the pixel units 210 has an active device TFT. The pixel units 210 are arranged to form at least one set of a first pixel unit column 212 and a second pixel unit column 214 adjacent to each other, and the pixel units 210 in the first pixel unit column 212 and the second pixel unit column 214 are vertically arranged. The scan lines G1, G2, and G3˜Gn and the data lines D1, D2, and D3˜Dn are electrically connected to the corresponding active devices of the pixel units 210, e.g. thin film transistors TFT. Herein, the data line D1 connected to the active devices TFT of the pixel units 210 of the first pixel unit column 212 and the data line D1 connected to the active devices TFT of the pixel units 210 of the second pixel unit column 214 form a closed loop. Especially, in the first pixel unit column 212, the active devices TFT of the pixel units 210 are connected to the scan lines of an odd-number position G1, G3, G5, . . . , and G₂ₙ₊₁ (n=0, 1, 2, 3 . . . ), and in the second pixel unit column 214, the active devices TFT of the pixel units 210 are connected to the scan lines of an even-number position G2, G4, G6, . . . , and G₂ₙ (n=1, 2, 3 . . . ).

Referring to FIG. 2, the first pixel unit column 212 and the second pixel unit column 214 adjacent to each other form a set of arrangement unit and a plurality of sets of arrangement units are sequentially arranged in a horizontal direction of the active device array substrate 200. Specifically, the first pixel unit column 212 and the second pixel unit column 214 adjacent to each other are deemed as a unit, and these units are sequentially arranged on the active device array substrate 200. The first set of the first pixel unit column 212 and the second pixel unit column 214 transmits signals through the data line D1 which is connected to each other and forms a closed loop, the n^{th} set of the first pixel unit column 212 and the second pixel unit column 214 transmits signals through the data line Dn which is connected to each other and forms a closed loop, and others can be deduced by applying the same.

Referring to FIG. 2, the color of the pixel units 210 of the first pixel unit column 212 transmitting signals through the data line D1 are red, and the color of the pixel units 210 of the second pixel unit column 214 transmitting signals through the data line D1 are green. The color of the pixel units 210 of the first pixel unit column 212 transmitting signals through the data line D2 are blue, and the color of the pixel units 210 of the second pixel unit column 214 transmitting signals through the data line D2 are red. Furthermore, the color of the pixel units 210 of the first pixel unit column 212 transmitting signals through the data line D3 are green, and the color of the pixel units 210 of the second pixel unit column 214 transmitting signals through the data line D3 are blue. Certainly, the color arrangement of the pixel units 210 are not limited to the foregoing example, and people skilled in the art can adopt a suitable color arrangement according to requirements.

In addition, the active devices TFT may be devices with three terminals (a gate, a drain and a source) such as thin film transistors. Furthermore, each pixel unit 210 further includes a pixel electrode PE. The pixel electrodes PE are electrically connected to the corresponding scan lines G1, G2, and G3˜Gn and the corresponding data lines D1, D2, and D3˜Dn by the active devices TFT.

Especially, as shown in FIG. 2, the pixel units 210 in the first pixel unit columns 212 and the pixel units 210 in the second pixel unit columns 214 are sequentially and alternately driven by the scan lines G1, G2, and G3˜Gn and the data lines D1, D2, and D3˜Dn. Specifically, the driving sequence is the most upper pixel unit 210 of the first pixel unit columns 212, the most upper pixel unit 210 of the second pixel unit columns 214, the second pixel unit 210 of the first pixel unit columns 212, the second pixel unit 210 of the second pixel unit columns 214, . . . , and so forth.

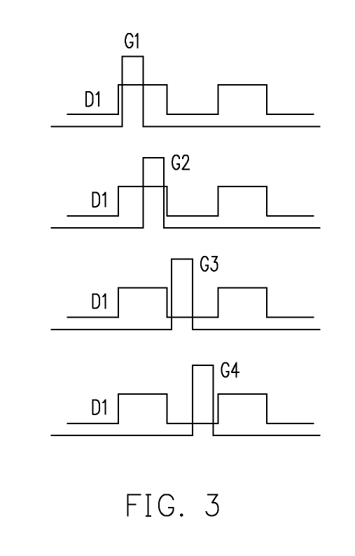

FIG. 3 is a timing diagram of driving waveforms of an active device array substrate according to an embodiment of the disclosure. Referring to FIG. 2 and FIG. 3, the first pixel unit columns 212 and the second pixel unit columns 214 transmitting signals through the data line D1 are exemplary for illustration. The scan lines G1 and G2 are conducted during frame times when square driving signals are applied, and accordingly, the positive voltage can be applied to the pixel units 210 connected with the scan lines G1 and G2. In addition, the scan lines G3 and G4 are conducted during frame times when square driving signals are not applied, and accordingly, the positive voltage can not be applied to the pixel units 210 connected with the scan lines G3 and G4. As known from above, the pixel units 210 of the active device array substrate 200 shown in FIG. 2 is driven by row inversion to display images. The foregoing active device array substrate 200 can adopt a well-known timing of driving waveforms, and changing the timing of driving waveforms is unnecessary. Certainly, the foregoing timing diagram of driving waveforms is simply exemplary, and people skilled in the art can adopt driving signals with suitable waveforms and amplitudes according to requirements.

Based on the above, the connection of the data lines D1, D2, and D3˜Dn and the arrangement of the active devices TFT of the active device array substrate 200 have been designed. Accordingly, the circuit area can be effectively utilized, and the possibility of forming line-cut is reduced. The foregoing active device array substrate 200 has a plurality of advantages, and it will be further illustrated as follows.

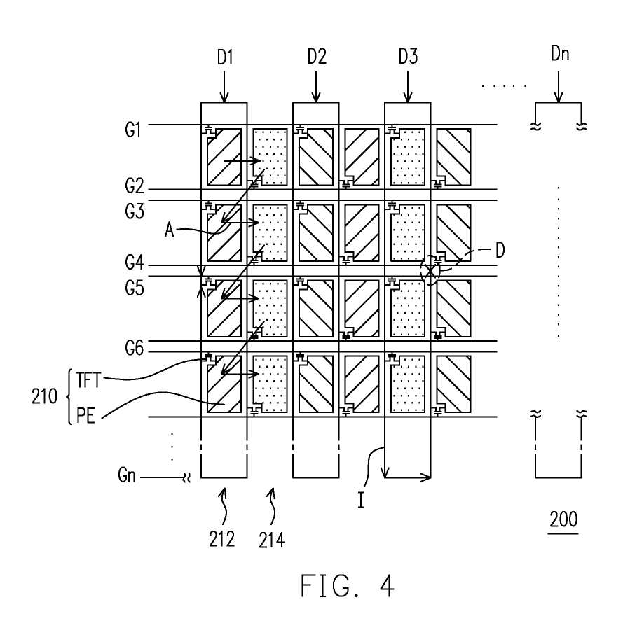

FIG. 4 is a schematic view illustrating the line-cut occurs in the active device array substrate shown in FIG. 2. Referring to FIG. 4, the third set of the first pixel unit column 212 and the second pixel unit column 214 are exemplary for illustration. The first pixel unit column 212 and the second pixel unit column 214 transmit driving signals through a closed loop formed by two data lines D3, D3 of which upper ends and lower ends are connected to each other. Accordingly, when the line-cut occurs in one of the data lines D3 (as shown at the region D), the driving signals can be still transmitted through a signal transmitting path I formed by the data line D3 having the line-cut and the other data line D3. As a result, the plurality of pixel units 210 of the first pixel unit column 212 and the second pixel unit column 214 can still be driven by exact data voltages.

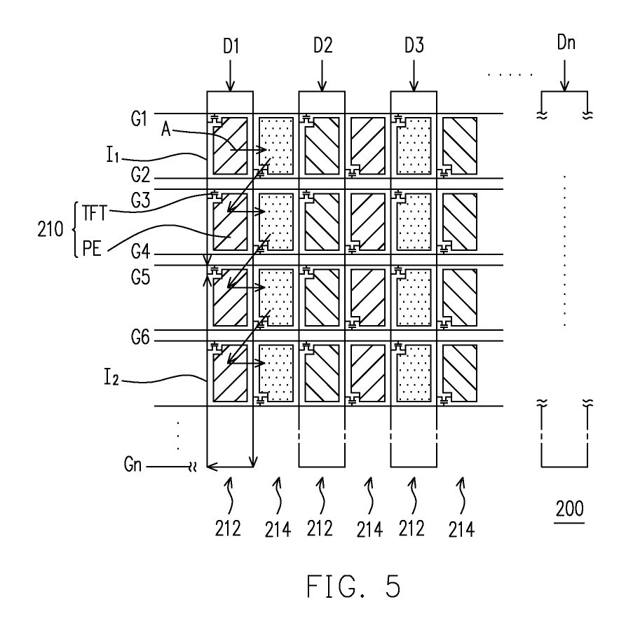

FIG. 5 is a schematic view illustrating signal transmitting paths in the active device array substrate shown in FIG. 2. Referring to FIG. 5, the driving signals from the data lines D1, D1 can be transmit to the active device TFT of the pixel unit 210 connected with the scan line G5 through signal transmitting paths I1 and I2. The driving signals are transmitted through two signal transmitting paths I1 and I2. That is to say, the impedance of the entire signal transmitting paths I1 and I2 becomes less, so that the attenuation of driving signals is reduced.

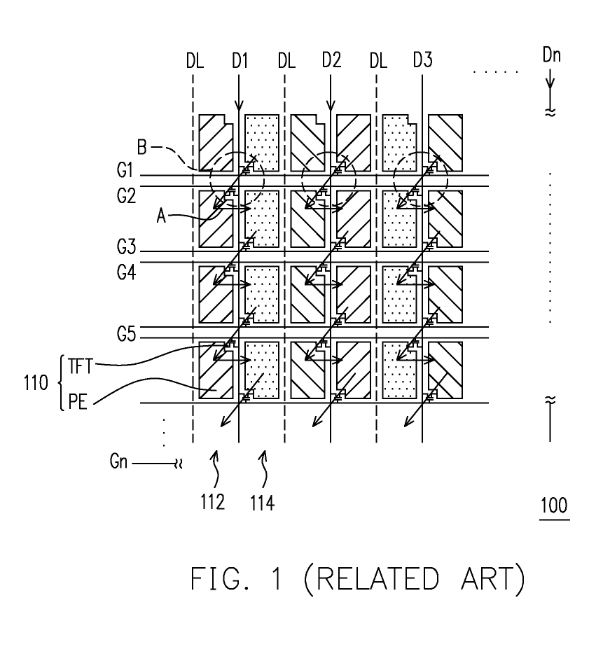

In addition, as known from comparing FIG. 1 of the prior art with FIG. 2 of the disclosure, as shown in FIG. 1 of the prior art, at each intersection (e.g. the region B) of any one of the data lines D1˜Dn (e.g. D1) and the scan lines G1˜Gn (e.g. G1 and G2), there are two active devices TFT located on the charging path A. However, as shown in FIG. 2 of the disclosure, at each intersection (e.g. the region C) of any one of the data lines D1˜Dn (e.g. D1) and the scan lines G1˜Gn (e.g. G1), there is only one active device TFT located on the charging path A. When more active devices TFT are located at the intersections of the data lines D1˜Dn and the scan lines G1˜Gn, the parasitic capacitances become greater. As known from above, the active device array substrate 200 of the present embodiment has the less parasitic capacitances by less active devices TFT, so that the display effect of the pixel units 210 is improved.

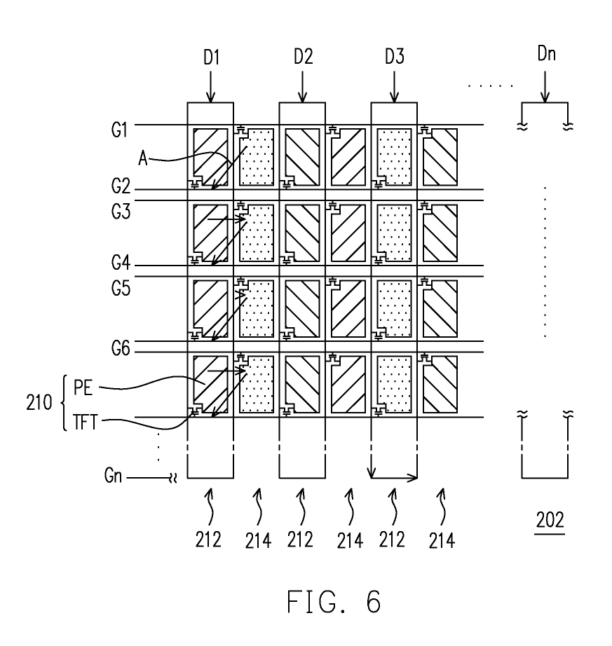

FIG. 6 is a schematic view of an active device array substrate according to another embodiment of the disclosure. Referring to FIG. 6, the active device array substrate 202 is similar to the active device array substrate 200 shown in FIG. 2, and same reference numbers refer to same elements. The difference therebetween lies in that, in the first pixel unit column 212, the active devices TFT of the pixel units 210 are connected to the scan lines of the even-number position G2, G4, G6, . . . , and G₂ₙ (n=1, 2, 3 . . . ), and in the second pixel unit column 214, the active devices TFT of the pixel units 210 are connected to the scan lines of the odd-number position G1, G3, G5, . . . , and G₂ₙ₊₁ (n=0, 1, 2, 3 . . . ). That is to say, the arrangements of the active devices TFT shown in FIG. 2 and FIG. 6 are different from each other. Similarly, the active device array substrate 202 has the same advantages as those of the active device array substrate 200. Especially, as shown in FIG. 6, the pixel units 210 in the second pixel unit columns 214 and the pixel units 210 in the first pixel unit columns 212 are sequentially and alternately driven by the scan lines G1, G2, and G3˜Gn and the data lines D1, D2, and D3˜Dn. Specifically, the driving sequence is the most upper pixel unit 210 of the second pixel unit columns 214, the most upper pixel unit 210 of the first pixel unit columns 212, the second pixel unit 210 of the second pixel unit columns 214, the second pixel unit 210 of the first pixel unit columns 212, . . . , and so forth.

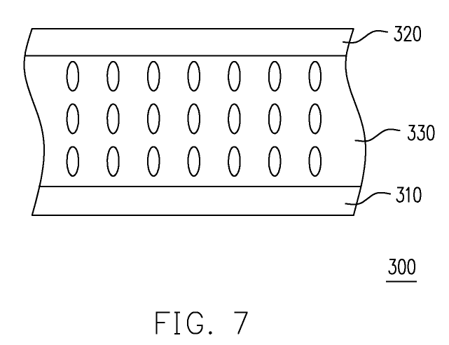

FIG. 7 is a schematic view illustrating an LCD panel according to an embodiment of the disclosure. The LCD panel 300 includes the active device array substrate 300, an opposite substrate 320 and a liquid crystal layer 330. The opposite substrate 320 is disposed opposite to the active device array substrate 310. The liquid crystal layer 330 is disposed between the active device array substrate 310 and the opposite substrate 320. In an embodiment, the opposite substrate 320 may be a color filter substrate. Alternatively, a color filter layer (not shown) may be disposed on the active device array substrate 310, and the opposite substrate 320 may be a transparent glass substrate.

It should be noted that, the foregoing active device array substrate 200 or 202 may be adopted as the active device array substrate 310. In this way, a good display quality is provided.

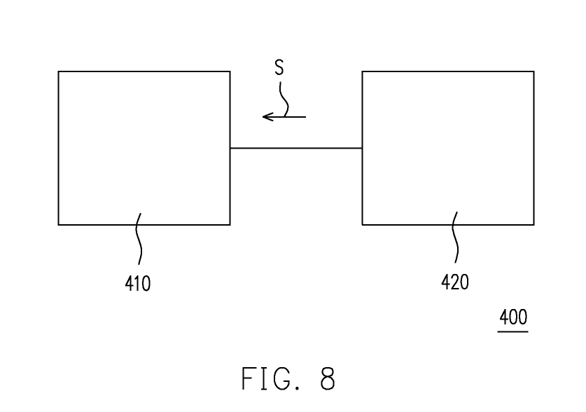

FIG. 8 is a schematic diagram of an electronic apparatus according to an embodiment of the disclosure. Referring to FIG. 8, the electronic apparatus 400 includes an LCD panel 410 and an input unit 420. The input unit 420 is coupled to the LCD panel 410 and used to input a signal to the LCD panel 410 for providing images. The foregoing LCD panel 300 shown in FIG. 7 may be adopted as the LCD panel 410.

In addition, the foregoing electronic apparatus 400 may be a mobile phone, a digital camera, a digital photo frame, a personal digital assistant (PDA), a notebook, a desktop computer, a television, a display, or a mobile DVD player, and the disclosure is not limited thereto.

In view of the above, the active device array substrate, the LCD panel, and the electronic apparatus of the disclosure have at least the following advantages.

Based on the above, in an embodiment of the disclosure, a new connection of data lines and a new arrangement of active devices are adopted. That is, the front ends and the back ends of two adjacent data lines are connected together and form closed loops. In addition, the timing of which the driving signals are read is controlled by the scan lines. As a result, the pixel electrodes are biased by exact voltages, and the number of data lines is half decreased. Especially, the front ends and the back ends of two adjacent data lines are connected, such that the circuit area is effectively utilized, and further the possibility of forming line-cut in pixel structures is reduced, the impedance of the signal transmitting paths is also reduced, and the general timing of driving waveforms can be still adopted.

Although the disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. An active device array substrate, comprising:
a plurality of pixel units, each of the pixel units having an active device, the pixel units arranged to form at least one set of a first pixel unit column and a second pixel unit column adjacent to each other, wherein the pixel units in the first pixel unit column and the second pixel unit column are vertically arranged; and
a plurality of scan lines and data lines, electrically connected to the corresponding active devices of the pixel units;
wherein, the data lines connected to the active devices of the pixel units of the first pixel unit column and the data lines connected to the active devices of the pixel units of the second pixel unit column form a closed loop, and
in the first pixel unit column, the active devices of the pixel units are connected to the scan lines of an odd-number position, and in the second pixel unit column, the active devices of the pixel units are connected to the scan lines of an even-number position; or
in the first pixel unit column, the active devices of the pixel units are connected to the scan lines of the even-number position, and in the second pixel unit column, the active devices of the pixel units are connected to the scan lines of the odd-number position.

2. The active device array substrate as claimed in claim 1, wherein the first pixel unit column and the second pixel unit column adjacent to each other form a set of arrangement unit and a plurality of sets of arrangement units are sequentially arranged in a horizontal direction of the active device array substrate.

3. The active device array substrate as claimed in claim 1, wherein the active device comprises a thin film transistor.

4. The active device array substrate as claimed in claim 1, wherein each of the pixel units further comprises:
a pixel electrode, electrically connected to the corresponding scan line and the corresponding data line by the active device.

5. The active device array substrate as claimed in claim 1, wherein in the first pixel unit column, the active devices of the pixel units are connected to the scan lines of the odd-number position, and in the second pixel unit column, the active devices of the pixel units are connected to the scan lines of the even-number position.

6. The active device array substrate as claimed in claim 5, wherein the pixel units in the first pixel unit column and the pixel units in the second pixel unit column are sequentially and alternately driven by the scan lines and the data lines.

7. The active device array substrate as claimed in claim 1, wherein in the first pixel unit column, the active devices of the pixel units are connected to the scan lines of the even-number position, and in the second pixel unit column, the active devices of the pixel units are connected to the scan lines of the odd-number position.

8. The active device array substrate as claimed in claim 7, wherein the pixel units in the second pixel unit column and the pixel units in the first pixel unit column are sequentially and alternately driven by the scan lines and the data lines.

9. The active device array substrate as claimed in claim 1, wherein a color of the pixel units in the first pixel unit column is red, and a color of the pixel units in the second pixel unit column is green.

10. The active device array substrate as claimed in claim 1, wherein a color of the pixel units in the first pixel unit column is blue, and a color of the pixel units in the second pixel unit column is red.

11. The active device array substrate as claimed in claim 1, wherein a color of the pixel units in the first pixel unit column is green, and a color of the pixel units in the second pixel unit column is blue.

12. A liquid crystal display panel, comprising:
an active device array substrate, comprising:
a plurality of pixel units, each of the pixel units having an active device, the pixel units arranged to form at least one set of a first pixel unit column and a second pixel unit column adjacent to each other, wherein the pixel units in the first pixel unit column and the second pixel unit column are vertically arranged; and
a plurality of scan lines and data lines, electrically connected to the corresponding active devices of the pixel units;
an opposite substrate disposed opposite to the active device array substrate; and
a liquid crystal layer disposed between the active device array substrate and the opposite substrate,
wherein, the data lines connected to the active devices of the pixel units of the first pixel unit column and the data lines connected to the active devices of the pixel units of the second pixel unit column form a closed loop, and
in the first pixel unit column, the active devices of the pixel units are connected to the scan lines of an odd-number position, and in the second pixel unit column, the active devices of the pixel units are connected to the scan lines of an even-number position; or
in the first pixel unit column, the active devices of the pixel units are connected to the scan lines of the even-number position, and in the second pixel unit column, the active devices of the pixel units are connected to the scan lines of the odd-number position.

13. The liquid crystal display panel as claimed in claim 12, wherein the opposite substrate is a color filter substrate.

14. An electronic apparatus, comprising:
a liquid crystal display panel, comprising:
an active device array substrate comprising:
a plurality of pixel units, each of the pixel units having an active device, the pixel units arranged to form at least one set of a first pixel unit column and a second pixel unit column adjacent to each other, wherein the pixel units in the first pixel unit column and the second pixel unit column are vertically arranged; and
a plurality of scan lines and data lines, electrically connected to the corresponding active devices of the pixel units;
an opposite substrate disposed opposite to the active device array substrate; and
a liquid crystal layer disposed between the active device array substrate and the opposite substrate; and
an input unit coupled to the liquid crystal display panel for inputting a signal to the liquid crystal display panel for providing images.

15. The electronic apparatus as claimed in claim 14, wherein the opposite substrate is a color filter substrate.

16. The electronic apparatus as claimed in claim 14, wherein the electronic apparatus is a mobile phone, a digital camera, a digital photo frame, a personal digital assistant, a notebook, a desktop computer, a television, a display, or a mobile DVD player.
